(19) United States
(12) Patent Application Publication
(10) Pub. No.: US 2010/0253738 A1
(43) Pub. Date: Oct. 7, 2010

(54) CARRIAGE-ACTUATED VENT SYSTEM FOR INKJET PRINT HEADS

(76) Inventors: Keith Jariabka, Portland, OR (US); Scott Martin, Vancouver, WA (US); Kieran B. Kelly, Vancouver, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/417,836

(22) Filed: Apr. 3, 2009

(51) Int. Cl. B41J 2/165

(52) U.S. Cl. 347/32

(57) ABSTRACT

A carriage-actuated venting system for a print head of an inkjet printer includes a print head cap, selectively closable over the print head of the ink jet printer. A vent port is in fluid communication with the print head cap and vents the print head when the print head cap is closed over the print head. A movable shaft is engageable by a movable carriage of the ink jet printer. A vent actuator is coupled to and movable with the shaft to close the vent port and restricts venting of the print head through the print head cap.

### BACKGROUND

Inkjet printers operate using a print head including a plurality of nozzles, which spray ink directly onto a print medium. Print head nozzles can become clogged with ink, particulates, or air resulting in inefficient operation of the print heads and reduced print quality. Therefore, inkjet printers usually include a service station that provides functions for maintenance of the print heads. In order to provide the maintenance functions to the print head at the service station, printers typically employ multiple drive motors, solenoids, and other actuation devices.

For example, in order to maintain good nozzle health it is desirable to have a properly vented print head when the printer is not in use (i.e. when a cap is closed over the print head nozzle array) and an un-vented print head when the print head is being primed (i.e. when a cap is closed over the print head nozzle array and a priming pump pulls a small volume of ink and air from the nozzles). Improper venting of the print head can cause drool, ink mixing, drying out, and air ingestion. Typically, print head vents, including those for print head caps, are actuated by solenoids or electric motors. Such actuation systems usually increase the complexity and cost of the printing device.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a perspective view of one embodiment of a carriage-actuated vent system in accordance with the present disclosure;

FIG. 2 is a left side perspective view of the carriage-actuated vent system of FIG. 1;

FIG. 3 is a schematic diagram showing the basic elements of the embodiment of the carriage-actuated vent system of FIG. 1, shown with a vent in an open position;

FIG. 4 is a schematic diagram of the embodiment of the carriage-actuated vent system of FIG. 1, shown with the vent in a another open position;

FIG. 5 is a schematic diagram of the embodiment of the carriage-actuated vent system of FIG. 1, shown with the vent in a closed position;

FIG. 6 is a schematic diagram showing the basic elements of another embodiment of a carriage-actuated vent system;

FIG. 7 is a schematic diagram showing the basic elements of an embodiment of an inkjet printer having a carriage-actuated vent system shown in a cutaway view; and

FIG. 8 is a flow chart outlining the steps in one embodiment of a method for venting a cap of a print head on a movable carriage of an inkjet printer.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

As used herein, directional terms, such as “top,” “bottom,” “front,” “back,” “leading,” “trailing,” etc, are used with reference to the orientation of the figures being described. Because components of various embodiments disclosed herein can be positioned in a number of different orientations, the directional terminology is used for illustrative purposes only, and is not intended to be limiting.

The exemplary embodiments described herein generally provide for a carriage-actuated venting system for an ink jet printer print head that uses the movement of the print head carriage to open or close a print head cap vent for either or both of the black and color print heads, when the print head carriage is in the service station position. The venting system can have a vent actuator that can be engaged by small movements of the print head carriage to open or close a vent port that is fluidly coupled to the print head cap. The vent actuator can be coupled to a shaft that also has a transmission gear for a primer pump transmission. The carriage motion is used to engage the pump transmission. The vent actuator moves are additional moves within the pump engaged position to either open or close the vent port.

In use, the movable print head carriage can move the shaft to engage the transmission gear of the primer pump transmission in order to pump fluid, such as ink and/or air, from the print head. When the transmission gear is in the engaged position, the carriage can further move the shaft incrementally in order to engage the vent actuator to close the vent port as a step in the priming operation, so that ink and/or air can be drawn from the print head. The carriage can also move the shaft incrementally to move the vent actuator and open the vent port while the primer pump is pumping ink and/or air, in order to evacuate or clear the print head cap and priming tubes, so as to prevent ink from entering the vent tube. When the primer pump is not engaged by the transmission gear on the movable shaft, the vent port is open to provide atmospheric venting to the print head.

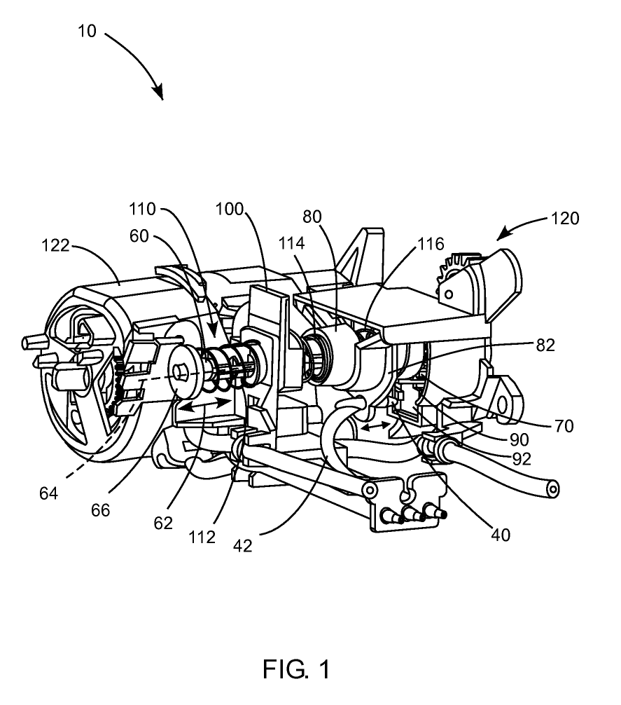

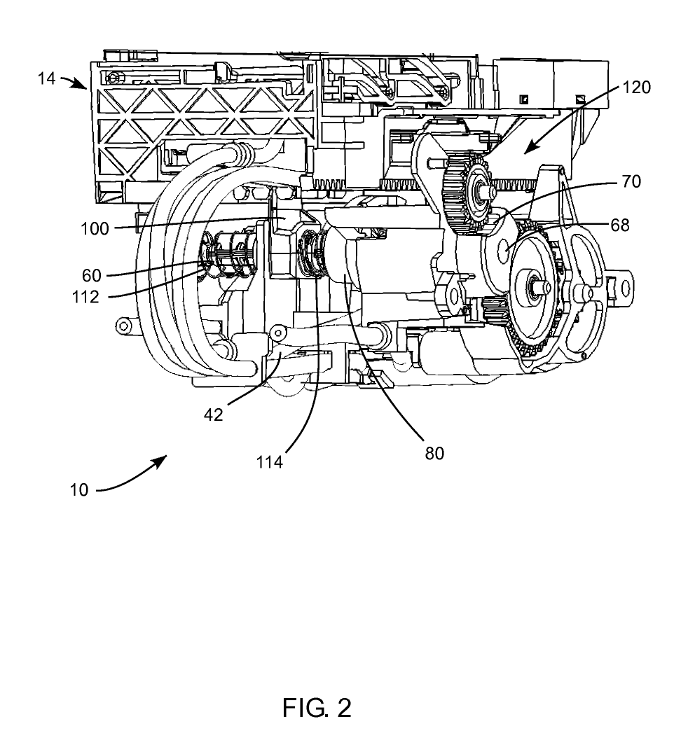

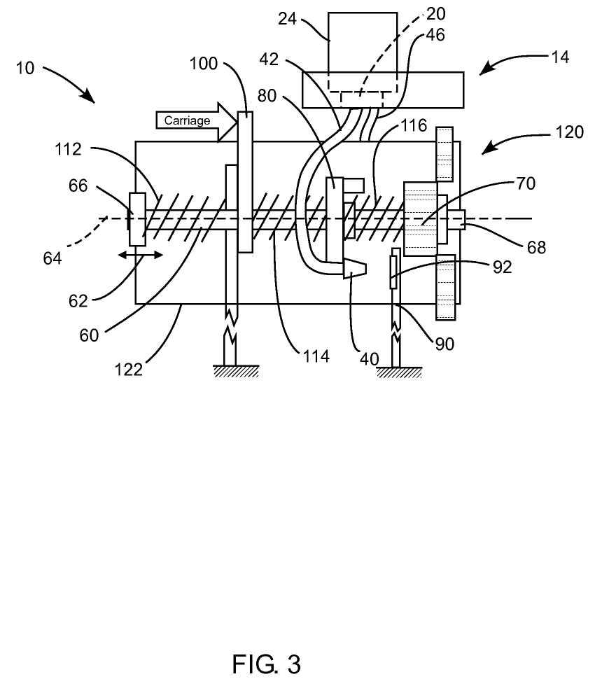

Provided in FIGS. 1-2 are perspective views of one embodiment of a carriage-actuated venting system, indicated generally at 10, for a print head (not shown) of an inkjet printer (not shown). The venting system 10 can include a print head cap 20 (FIG. 3) that can cover the print head, a vent port 40 in fluid communication with the print head cap, a movable shaft 60, and a vent actuator 80 coupled to the movable shaft that can close the vent port.

The print head cap 20 can be selectively closable over the print head nozzle array of the ink jet printer. The print head cap can be located in a service station, indicated generally at 14 (FIG. 2), of the ink jet printer. As the movable print head carriage (not shown) moves the print head to the service station 14, the print head nozzle array can be covered by the print head cap.

The vent port 40 can be in fluid communication with the print head cap 20. For example, a vent tube 42 can extend between the print head cap and the vent port. In this way, the vent port can vent the print head when the print head cap is closed.

The vent tube 42 can provide an alternate path from the print head cap 20 to atmosphere which provides a clear vent path and, thus, mitigates the problems of ink accumulation found with vents that are in-line with the pump or ink source. It will be appreciated that other systems that use venting systems that are vented through the primer pump via the priming tubes can become clogged with ink froth, ink crust and accumulation which can inhibit the function of the vent.

The movable shaft 60 is engageable by the movable carriage of the ink jet printer. The movable shaft can move in a longitudinal direction, indicated by the arrow at 62, along a longitudinal axis 64 of the shaft. The longitudinal direction can be substantially parallel to a direction of travel of the movable carriage. The shaft includes a carriage end 66 and a transmission end 68 (FIG. 2). A transmission gear 70 can be coupled to the shaft on the transmission end.

The vent actuator 80 is coupled to and movable with the shaft 60. In the embodiment shown in FIGS. 1-2, the vent actuator includes a bracket 82 coupled to the movable shaft 60 and the vent port 40 such that the vent port is movable by the vent actuator 80.

The vent system 10 also includes a vent stop 90. The vent stop is fixed with respect to the vent actuator 80. The vent stop can be moved by the vent actuator 80 to close the vent port 40 against the vent stop when the vent actuator is moved to the closed position. The vent stop can include a rubber pad 92 that can be positioned against and seal the vent port when the vent actuator is in the closed position.

The vent system 10 also includes a shifter 100 movably disposed on the movable shaft 60. The shifter can be engaged and moved by the movable carriage of the inkjet printer. The shifter moves the shaft and the vent actuator 80 when the shifter is moved by the movable carriage. In this way, the vent port 40 can be closed by the movable carriage of the inkjet printer when the movable carriage engages and moves the shifter, which moves the vent actuator, which in turn engages the vent port to close the port.

Additionally, a biasing system, indicated generally at 110, can bias the shifter 100 to a neutral position with the vent actuator 80 disengaged from the vent port 40 so that the vent port is open. In the embodiment shown in FIGS. 1-2, the biasing system includes a plurality of springs disposed sequentially on the movable shaft 60 between the shifter, the vent actuator, and opposite ends 66 and 68 of the movable shaft.

The plurality of springs can include a shifter spring 112, a vent actuator spring 114, and a gear spring 116. The shifter spring is disposed on the movable shaft 60 between the proximal or carriage end 66 of the movable shaft 60 and the shifter 100. The shifter spring resists movement of the shifter toward the proximal end. The vent actuator spring is disposed on the movable shaft 60 between the shifter 100 and the vent actuator 80 to resist movement of the vent actuator toward the shifter. The gear spring is disposed on the movable shaft 60 between the vent actuator 80 and a distal or transmission end 68 of the movable shaft. The gear spring resists movement of the vent actuator toward the transmission end. Together the shifter spring 112, vent actuator spring 114, and gear spring 116 can maintain the movable shaft 60, the shifter 100, and the vent actuator 80 in the neutral position, as shown in FIG. 1.

The transmission gear 70 is coupled to the transmission end 68 of the movable shaft 60. The transmission gear 70 can fit a transmission, shown generally at 120, for a primer pump 122 that pumps ink and/or air from the print head 24. When the shaft 60 is moved by the movable carriage to a pump engagement position, the transmission gear engages the pump transmission, which can then drive the pump. Additionally, the movable carriage can move the movable shaft 60 incrementally over small distances within the pump engagement position, while maintaining engagement of the transmission gear 70 with the transmission 120, so as to open or close the vent port 40 with the transmission engaged.

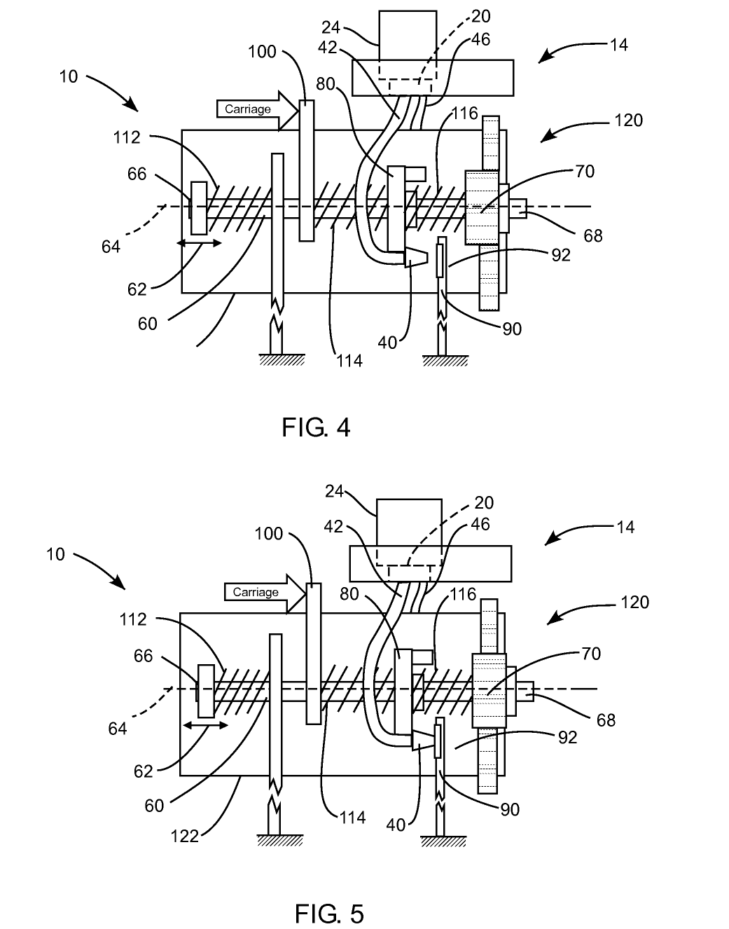

To illustrate this movement, FIGS. 3-5 provide schematic diagrams of the vent system 10 with the movable shaft 60, the vent actuator 80, and the vent port 40 moved between the neutral position with the transmission gear 70 disengaged, as shown in FIG. 3, an open position with the transmission gear 70 engaged, as shown in FIG. 4, and a closed position with the transmission gear 70 engaged, as shown in FIG. 5. In the closed position (FIG. 5), the vent actuator engages the vent port 40 to close the vent port and restrict venting of the print head through the print head cap 20, such that ink and/or air can be primed from the print head 24. In the open position (FIG. 4), the vent port is disengaged from the vent actuator and is open to vent the print head cap, such that ink can be removed from the cap 20 and priming tubes 46.

Thus, when the transmission gear 70 is in the engaged position, the movable carriage can further move the shaft incrementally in the direction of the transmission 120, in order to allow the vent actuator 80 to engage and close the vent port 40 while the transmission is driving the primer pump, as shown in FIG. 5. With the vent port closed, ink can be pumped through the print head by the primer pump.

The carriage can also move the shaft 60 incrementally away from the transmission 120 to disengage the vent actuator 80 from the vent port 40 while the primer pump 122 (FIG. 1) is pumping ink to the print head, as shown in FIG. 4. With the vent port open during the operation of the primer pump, the print head cap 20 and primer pump tubes 46 can be evacuated or cleared by the suction from the primer pump.

The opening and closing of the carriage-actuated venting system 10 is done in order to allow the print heads to be primed when the vent system is closed and to allow ink to be removed from the pump tubes and print head cap 20 when the vent port 40 is open. In this way, the carriage-actuated vent system assists in maintaining a substantially clear and ink-free vent path for the print head while the nozzles of the print head are capped for storage. The alternate vent path provided by the vent tube 42 and vent port 40 of the carriage-actuated venting system allows for priming, evacuating, and cap storage venting all to be performed while the print head is capped.

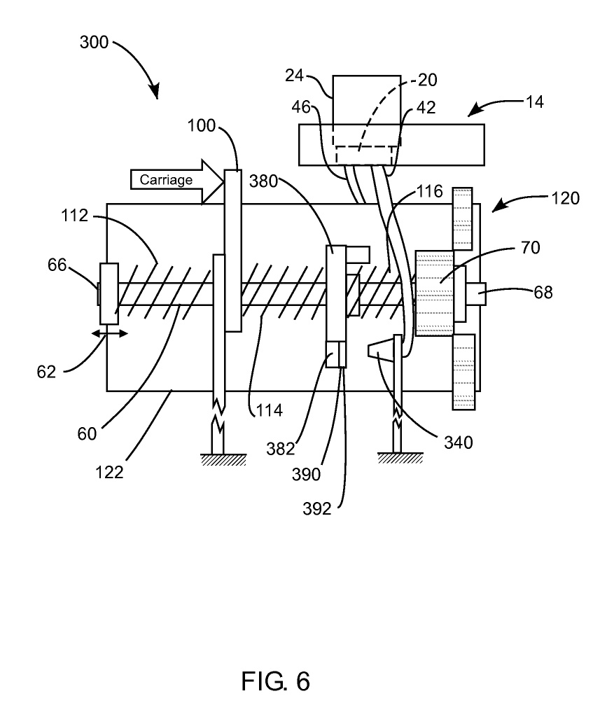

Turning to FIG. 6, a schematic diagram of another embodiment of a carriage-actuated venting system, indicated generally at 300, is shown for a print head of an inkjet printer (not shown). The venting system 300 can be similar in many respects to the venting system 10 shown in FIGS. 1-2 and described above. This vent system 300 includes a print head cap 20 that can cover the print head, a vent port 340 in fluid communication with the print head cap, a movable shaft 60, and a vent actuator 380 coupled to the movable shaft, for closing the vent port.

The vent system 300 also includes a vent stop 390. The vent stop is engageable by the vent actuator 380 to close the vent port 340 when the vent actuator is moved to the closed position. The vent stop can include a rubber pad 392 that becomes positioned against the vent port and seals the vent port when the vent actuator is in the closed position.

The vent actuator 380 includes a bracket 382 coupled to the movable shaft 60 and the vent stop 390 such that the vent stop is movable by the vent actuator. The vent port 340 is fixed with respect to the vent actuator. The vent actuator moves the vent stop to engage the vent port when the vent actuator is moved to the closed position by the movable shaft.

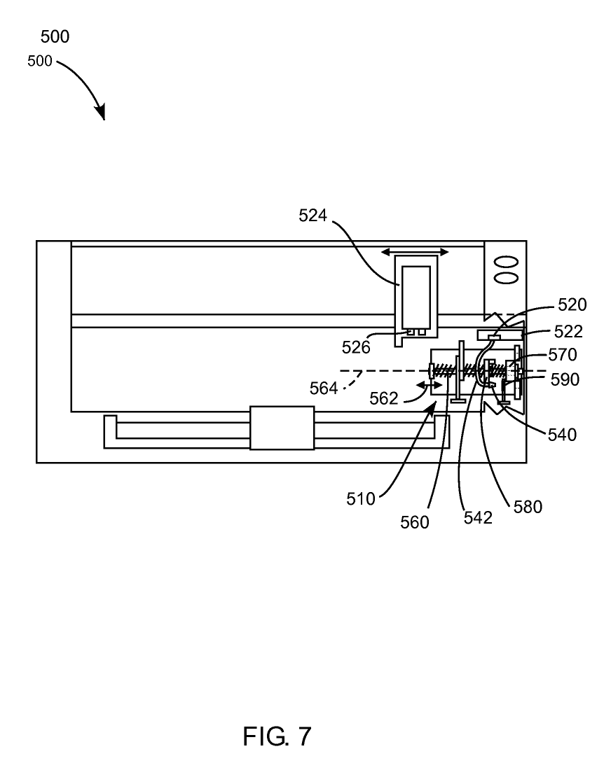

Provided in FIG. 7 is a schematic diagram of an embodiment of an inkjet printer, indicated generally at 500. The inkjet printer includes a movable carriage 524 with a print head 526, and a carriage-actuated venting system, indicated generally at 510. The system includes a print head cap 520 that can cover the print head, a vent port 540 in fluid communication with the print head cap, a movable shaft 560, and a vent actuator 580 coupled to the movable shaft for closing the vent port. The vent system 510 can also include a vent stop 590.

As noted above, the movable shaft 560 is engageable by the movable carriage 524 of the ink jet printer. The movable shaft can move in a longitudinal direction, indicated by the arrow at 562, along a longitudinal axis 564 of the shaft. The longitudinal direction can be substantially parallel to a direction of travel of the movable carriage, indicated by the arrow 580.

In use, the movable carriage 524 can move the print head 526 to a service station 522, where the print head is maintained and serviced to maintain quality printing standards. In the service station, the movable carriage can contact and move the movable shaft 560 so that the transmission gear 570 engages the pump transmission to drive the pump and prime the print head. When the transmission gear is in the engaged position and the pump is priming the print head, the movable carriage can then incrementally move the shaft to engage the vent actuator 580 to close the vent port 540 during the priming operation so that ink and/or air can be drawn from the print head. When the priming operation is complete, the movable carriage can incrementally move the shaft so that the vent actuator disengages and opens the vent port while the primer pump is still pumping so that ink can be evacuated or cleared from the cap 520 and priming tubes 46 without ink entering the vent tube 542.

Thus, advantageously, opening and closing of the vent can be done simultaneous with operation of the pump to provide a virtually continuous prime routine. Additionally, a substantially continuous prime routine is more acoustically pleasing than one that is interrupted by multiple shifts. The reduction in shifting also enhances reliability because fewer shifts reduce the likelihood of failure of the moving parts.

Additionally, the carriage-actuated vent system 510 described above vents the print head cap 520 while the print head 526 of the ink jet printer 500 is in storage in the service station 522 and capped by the print head cap. Advantageously, such venting helps prevent ink drool from and drying out or crusting of the print head nozzles.

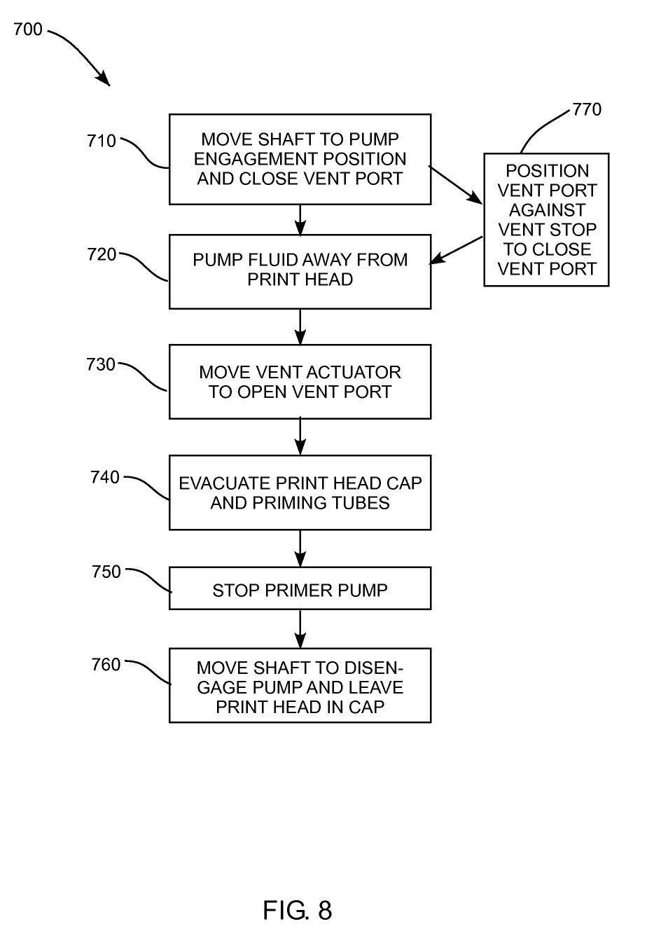

Provided in FIG. 8 is a flow chart outlining the steps in one embodiment of a method for venting a cap of a print head on a movable carriage of an inkjet printer and priming the print head. The method, indicated generally at 700, includes first moving the movable carriage to a pump engagement position (step 710). In this step a transmission gear on a shaft associated with the moveable carriage becomes engaged with a transmission of a primer pump, and a vent actuator is moved to close a vent port in fluid communication with the print head cap. In step 720, fluid, such as ink and/or air, is pumped away from the print head with the primer pump. In step 730, the shaft is then moved by the movable carriage within the engagement position to move a vent actuator to open a vent port in fluid communication with the print head cap while the primer pump is pumping. In step 740, the print head cap and priming tubes are evacuated by pumping with the primer pump. Next, the pump is stopped in step 750. The shaft is then moved by the movable carriage to disengage the pump transmission and leave the print head in the print head cap with the vent port open to vent the print head to the atmosphere, as shown in step 760. In the method, the vent actuator can be moved by the movable carriage to position the vent port against a vent stop to block or close the vent port as shown in step 770.

It will be appreciated that the embodiments of the venting systems described herein can be used to vent black ink print heads, color ink print heads, or both black and color print heads. The ability to vent both black and color actively offers some advantages to the user. For example, using a carriage-actuated vent system as disclosed herein reduces the need for solenoid-actuated venting valves, which reduces the overall cost of the printing device. Additionally, actively venting black as well as color print heads gives the nozzles of the print heads similar venting conditions, which results in substantially equalizing longevity and reliability of both the black and color print heads. This reliable venting helps ensure that the print nozzles stay healthy and do not dry out, drool, crust, or otherwise get damaged during capped storage of the printer, and results in improved image quality, reduced smear occurrences, and other causes of ink migration.

Additionally, with the carriage-actuated vent systems and method described above, if both black and color are in need of priming at the same time, as in the case of printer initialization, the two channels can be primed in sequence with only one shift of the movable shaft to the primer transmission engagement position. Advantageously, this can result in a faster initialization than some other pump-vented systems.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A carriage-actuated venting system for a print head of an inkjet printer, comprising:
a) a print head cap, selectively closable over the print head;
b) a vent port, selectively in fluid communication between the print head cap and atmosphere when the cap is closed;
c) a movable shaft, engageable by a movable carriage of the ink jet printer; and
d) a vent actuator, coupled to and movable with the shaft, to close the vent port.

2. A system in accordance with claim 1, further comprising:
a vent stop, engageable by the vent actuator, to close the vent port when the vent actuator is moved to close the vent port.

3. A system in accordance with claim 2, wherein the vent actuator includes a bracket, coupled to the vent port, such that the vent port is movable by the vent actuator, and the vent stop is fixed with respect to the vent actuator, and wherein the vent actuator moves the vent port to engage the vent stop when the vent actuator is moved to close the vent port.

4. A system in accordance with claim 2, wherein the vent actuator includes a bracket coupled to the vent stop, such that the vent stop is movable by the vent actuator and the vent port is fixed with respect to the vent actuator, and wherein the vent actuator moves the vent stop to engage the vent port when the vent actuator is moved to close the vent port.

5. A system in accordance with claim 2, wherein the vent stop includes a rubber pad, sealably positionable against the vent port.

6. A system in accordance with claim 1, further comprising:
e) a shifter, movably disposed on the shaft and movable by the movable carriage, and engageable with the vent actuator when moved by the movable carriage; and
f) a biasing system, configured to bias the shifter to a neutral position and the vent actuator away from closing the vent port.

7. A system in accordance with claim 6, wherein the biasing system further comprises:
a plurality of springs disposed sequentially on the shaft between the shifter, the vent actuator, and opposite ends of the shaft, the plurality of springs including:
i) a shifter spring, disposed on the shaft between a proximal end of the shaft and the shifter, to resist movement of the shifter toward the proximal end;
ii) a vent actuator spring, disposed on the shaft between the shifter and the vent actuator, to resist movement of the vent actuator toward the shifter; and
iii) a bias spring, disposed on the shaft between the vent actuator and a distal end of the shaft, to resist movement of the vent actuator toward the distal end.

8. A system in accordance with claim 1, wherein the moveable shaft further includes:
a transmission gear, engageable with a primer pump for pumping fluids from the print head when the shaft is moved by the movable carriage to a pump engagement position; and
wherein the movable carriage moves the shaft within the pump engagement position to move the vent actuator between a closed position and an open position.

9. An inkjet printer, comprising:
a) a movable carriage, having a print head;
b) a cap, closeable over the print head;
c) a shaft, extending substantially parallel to a direction of travel of the movable carriage;
d) a vent actuator, movably disposed on the shaft and engageable by the movable carriage to move the vent actuator along the shaft to a closed position;
e) a vent port, in fluid communication with the print head cap to vent the print head when the cap is closed, and engageable by the vent actuator when the vent actuator moves to the closed position; and
f) a vent stop, engageable by the vent port to close the vent port when the vent actuator is in the closed position.

10. The system of claim 9, wherein the vent stop is fixed with respect to the vent actuator, and the vent actuator includes a bracket, coupled to the vent port, such that the vent port is movable by the vent actuator, and wherein the vent actuator moves the vent port to engage the vent stop when the vent actuator is moved to the closed position.

11. The system of claim 9, wherein the vent port is fixed with respect to the vent actuator, and the vent actuator includes a bracket, coupled to the vent stop, such that the vent stop is movable by the vent actuator, and wherein the vent actuator moves the vent stop to engage the vent port when the vent actuator is moved to the closed position.

12. A printer in accordance with claim 9, further comprising:
a shifter, movably disposed on the shaft and movable on the shaft by the print head carriage to engage and move the vent actuator on the shaft; and
a biasing system, configured to bias the shifter to a neutral position and the vent actuator away from the closed position.

13. A printer in accordance with claim 12, wherein the shaft further includes:
a transmission gear, engageable with a primer pump for pumping ink to the print head when the shaft is moved by the print head carriage to a pump engagement position; and
wherein the print head carriage moves the shaft within the pump engagement position to move the vent actuator between a closed position and an open position.

14. A method for venting a cap of a print head on a movable carriage of an inkjet printer and priming the print head, comprising the steps of:
a) moving a shaft with the movable carriage to an engagement position to engage a transmission gear on the shaft with a transmission of a primer pump for pumping fluid from the print head, and to move a vent actuator to close a vent port in fluid communication with the print head cap;
b) pumping fluid away from the print head with the primer pump;
c) moving the shaft with the movable carriage within the engagement position to move the vent actuator to open the vent port while the primer pump is pumping;
d) pumping with the primer pump to evacuate the print head cap and priming tubes;
e) stopping the primer pump; and
f) moving the shaft with the movable carriage to disengage the pump transmission, to place the print head in the print head cap, and to open the vent port to vent the print head to the atmosphere.

15. A method in accordance with claim 14, further comprising the step of moving the vent actuator to position the vent port against a vent stop to block the vent port.
